(19) United States
(12) Patent Application Publication
(10) Pub. No.: US 2003/0164183 A1
(43) Pub. Date: Sep. 4, 2003

(54) Rotary car wash cell

(76) Inventor: Paul Manfred Gingl, Kettleby (CA)

Correspondence Address: Robin W. Asher, Clark Hill PLC, Suite 3500, 500 Woodward Avenue, Detroit, MI, 48226-3435, US

(21) Appl. No.: 10/345,623

(22) Filed: Jan. 15, 2003

Related U.S. Application Data
(60) Provisional application No. 60/349,178, filed on Jan. 15, 2002.
(60) Provisional application No. 60/382,958, filed on May 24, 2002.

(51) Int. Cl. B08B 3/00

(52) U.S. Cl. 134/125; 134/131

(57) ABSTRACT

A rotary car washing cell includes a platform for supporting an automotive vehicle and rotatably coupled to a base for rotating the vehicle about a fixed axis. The platform includes a guide rail disposed along a predetermined path on the platform. A support frame is fixedly secured to the base. A wash arm assembly for spraying fluid onto the vehicle is slidably supported by the support frame for radial movement with respect to the fixed axis. The wash arm assembly including a cam follower for engaging the guide rail during rotation of the platform, whereby the wash arm assembly is radially displaced with respect to the fixed axis in response to the rotation of the platform about the fixed axis.

### RELATED APPLICATIONS

This patent application claims priority to and all the benefits of the U.S. Provisional Patent Application No. 60/349,178 filed on Jan. 15, 2002 and 60/382,958 filed on May 24, 2002.

### BACKGROUND OF THE INVENTION

1. Field of the Invention

The invention relates to a rotary car wash cell for washing and drying an automotive vehicle, and more particularly, to a movable wash arm assembly that is radially displaceable in response to a rotating platform supporting the vehicle.

2. Description of the Related Art

Many types of automatic vehicle wash system exist. In so-called tunnel-type car wash systems, a vehicle is advanced on a track system along a linear path with different operations occurring at various stages. The various stages include, for example, pre-soaking, rinsing, scrubbing, waxing, and other similar operations. Generally, in a tunnel-type wash system, a cloth curtain, comprised of a plurality of strips, is rocked back and forth to abrasively scrub and remove dirt and other debris from the surface of the vehicle as the vehicle is moved along. Although this scrubbing action normally takes place in combination with soapy water, repeated usage of such a cleaning system has been shown to have a detrimental effect on the paint because minor scratches are imparted to the surface.

Consequently, many vehicle owners prefer not to use tunnel-type wash systems and instead prefer to use a system wherein water is merely directed at the surface of the vehicle in a high-pressure stream to remove dirt and other material from the surface thereof. In this type of system, jet sprays of water impact against the side of a vehicle through an array of nozzles disposed along both sides and across the top of the vehicle. Such arrays typically move in a loop around the vehicle with the vehicle remaining stationary while others move relative to the vehicle in a straight line along the length of the vehicle. In either case, the object is to expose the entire exterior surface of the vehicle to the jet sprays of water to remove dirt, scum and other road debris from the surface of the vehicle.

Unfortunately, with such “touch-less” systems, it is difficult to wash the front and rear of the vehicle as the nozzles through which the cleaning fluid is dispensed are usually directed perpendicularly to the line of movement of the apparatus and therefore are not directed at the front and rear of the vehicle. More complicated systems solve this problem by utilizing rotating nozzles that move along overhead tracks, but this adds complexity and cost to the system.

Furthermore, both types of conventional systems are rather large because the vehicle travels in a linear direction, typically through a rectangular structure that has separate wash and dry stations.

Therefore, an object of the present invention to provide a car wash system of the type wherein the front and rear of the vehicle, as well as the top and sides, are thoroughly cleaned. A further object is to accomplish both washing and drying cycles in one extremely compact facility.

### SUMMARY OF THE INVENTION

According to one aspect of the invention, a rotary car washing cell is disclosed. The rotary car washing cell includes a platform for supporting an automotive vehicle and rotatably coupled to a base for rotating the vehicle about a fixed axis. The platform includes a guide rail disposed along a predetermined path on the platform. A support frame is fixedly secured to the base. A wash arm assembly for spraying fluid onto the vehicle is slidably supported by the support frame for radial movement with respect to the fixed axis. The wash arm assembly including a cam follower for engaging the guide rail during rotation of the platform, whereby the wash arm assembly is radially displaced with respect to the fixed axis in response to the rotation of the platform about the fixed axis.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a side view of a rotary car wash cell according to one aspect of the invention;

FIG. 2 is a front view of the rotary car wash cell;

FIG. 3 is a perspective view of the rotary car wash cell;

FIG. 4 is a top view of the rotary car wash cell;

FIG. 5 is a top view of a support rail in the rotary car wash cell;

FIG. 6 is a front view of a pipe having a plurality of spouts for spraying fluid onto a vehicle in the rotary car wash cell;

FIG. 7 is an enlarged view of a cam follower coupled to the pipe for displacing the pipe in response to rotation of a platform within the rotary car wash cell;

FIG. 8 is an alternative embodiment of the cam follower

FIG. 9 is a side view of the rotary car wash cell including horizontal pipes for spraying fluid to the underside of the vehicle;

FIG. 10 is an alternative embodiment of the rotary car wash cell;

FIG. 11 is a second embodiment of the rotary car wash cell; and

FIG. 12 is a third embodiment of the rotary car wash cell.

### DETAILED DESCRIPTION OF THE PREFERRED EMBODIMENT

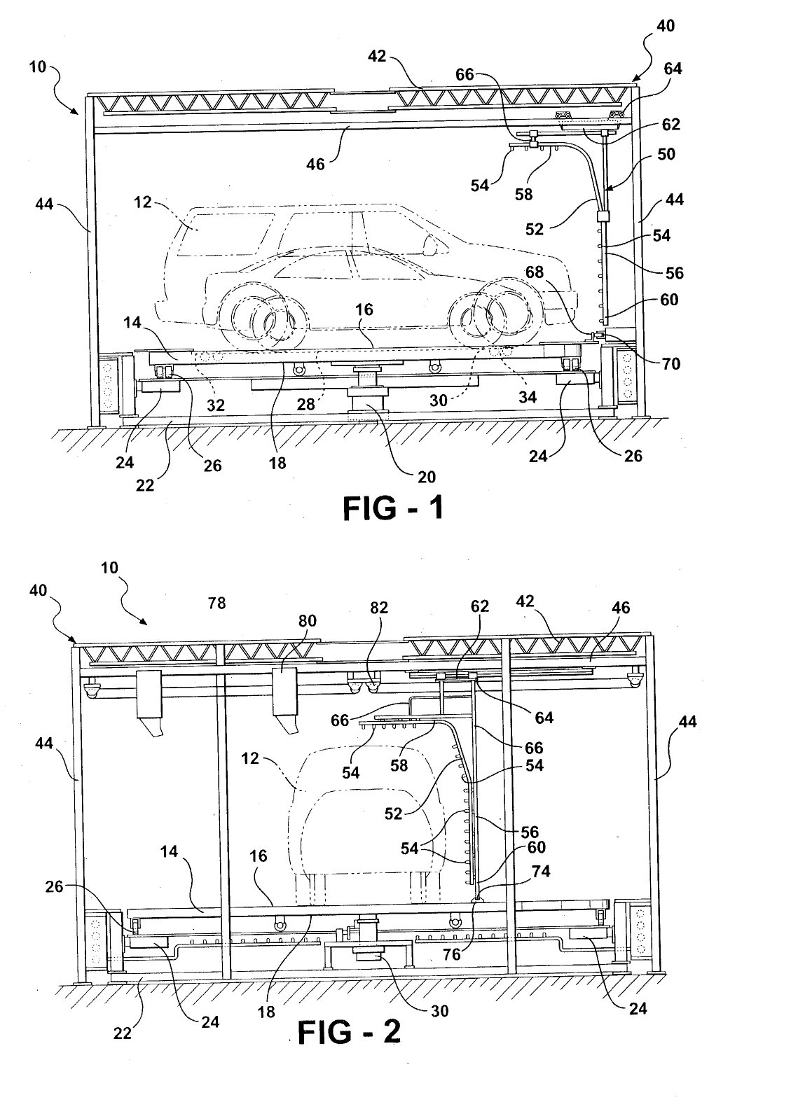

Referring to the FIGS. 1-4 and 9, a washing cell is generally indicated at 10 for washing an automotive vehicle 12. The washing cell 10 includes a platform 14 having an upper surface 16 for receiving and supporting the vehicle and an opposite lower surface 18. The platform 14 is rotatably supported and driven by a motor 20 for rotation about a fixed axis. The platform 14 is stabilized by a base 22 having a generally annular track 24. A plurality of wheels 26 are rotatably coupled to the lower surface 18 of the platform 14 for rolling along the annular track 24 of the base 22 as the platform 14 is rotatably driven by the motor 20.

The platform 14 includes spaced apart guide rails 28 for guiding the wheels the vehicle 12 as it is driven onto and off of the platform 14. Each guide rail 28 extends between front 30 and rear 32 ends. A depression 34 is formed toward the front end 30 of at least one of the guide rails 28 for receiving a front wheel of the vehicle 12 to define a generally central position of the vehicle 12 within the washing cell 10.

The washing cell 10 also includes a support frame 40. The support frame 40 includes a generally horizontal cross member 42 supported vertically above the platform 14 by spaced apart vertical members 44 that are fixedly secured to the base 22. A support rail 46 is fixedly carried by the cross member 42.

A wash arm assembly 50 is operatively coupled to the support rail 46 for generally radial movement relative to the vehicle 12 that is supported on the platform 14. The wash arm assembly 50 includes at least one pipe 52 for receiving and spraying fluid through a plurality of holes or spouts 54 disposed longitudinally along the pipe 52. Preferably, the pipe 52 includes a generally vertical portion 56 for spraying fluid onto the sides of the vehicle 12 and a generally horizontal portion 58 for spraying fluid onto the roof the vehicle 12. The pipe 52 also includes a lower distal end 60. Multiple pipes 52 can be utilized to receive and spray various fluids onto the vehicle 12, as shown in FIG. 6.

The wash arm assembly 50 includes a carrier 62 that is slidably coupled to the support rail 46 by a plurality of rollers 64. The pipe 52 is vertically supported by at least one arm 66 fixedly secured to the carrier 62, such that the pipe 52 moves with the carrier 62 along the support rail 46.

Referring to FIGS. 1 and 7, a guide loop or rail 68 for the wash arm assembly 50 is fixedly secured to the upper surface 16 of the platform 14 along a predetermined path around the general periphery of the platform 14. A cam follower 70 is rotatably coupled to the lower distal end 60 of the pipe 52 to rollingly engage the guide rail 68. The cam follower 70 continuously maintains engagement with the guide rail 68 during rotation of the platform 14. The radial distance of the guide rail 68 relative to the fixed axis of the platform 14 varies so that the guide rail 68 acts upon the cam follower 70 to radially displace the wash arm assembly 50 in response to the rotation of the platform 14. Preferably, an air spring 72 or similar shock absorber is coupled between the cam follower 70 and the lower distal end 60 of the pipe 52 to isolate the wash arm assembly 50 from vibrations from the platform 14. Alternatively, a guide foot 74 can be coupled to the lower distal end 60, as shown in FIGS. 2 and 8, for slidably engaging a recessed rail 76 in the platform 14 for radially displacing the wash arm assembly 50 in response to the rotation of the platform 14.

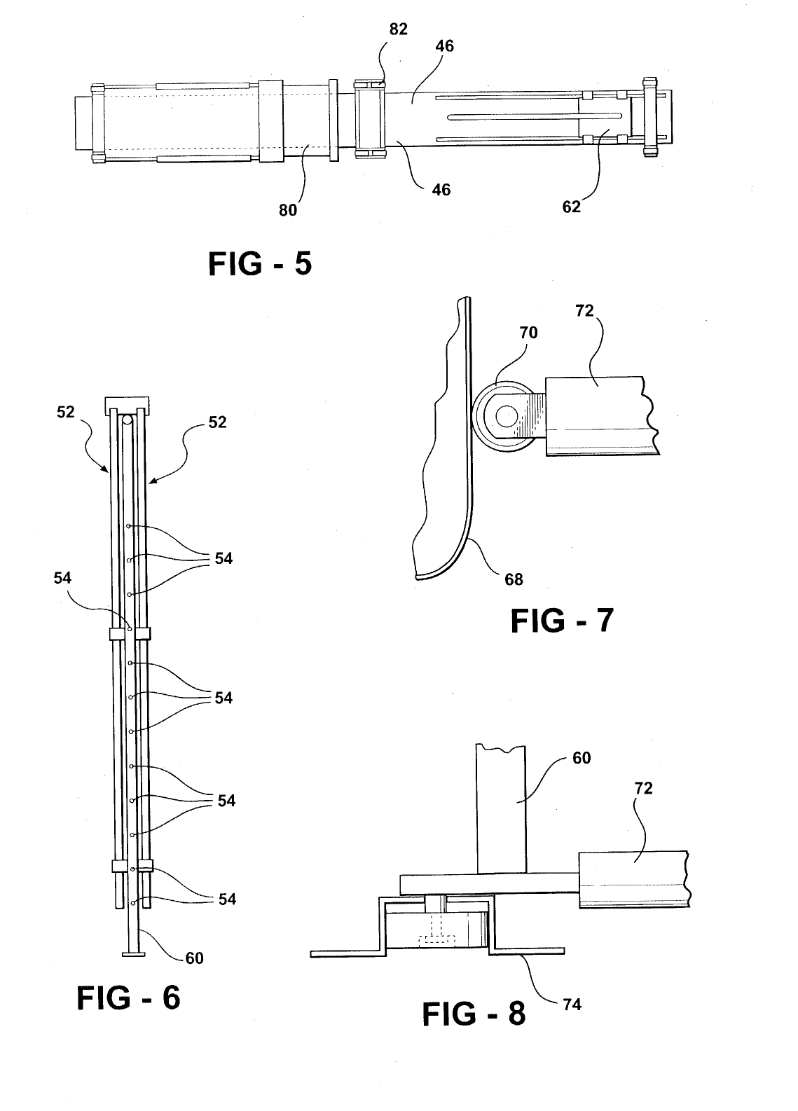

Referring to FIGS. 2 and 5, at least one dryer is coupled to the support frame 40 for blowing air onto the vehicle 12 as the platform 14 rotates. Preferably, a combination of a fixed dryer 78 and a mobile dryer 80 is carried by the support frame 40. More specifically, the mobile dryer 80 is slidably coupled to the support rail 46 for generally radial movement relative to the fixed axis of the platform 14. A pulley assembly 82 extends between the mobile dryer 80 and the wash arm assembly 50 so that the mobile dryer 80 moves radially with the wash arm assembly 50 in response to the rotation of the platform 14. A gear mechanism (not shown) can be coupled between wheels 84 in the pulley assembly 82 to increase or decrease the amount of radial displacement of the mobile dryer 80 with respect to the wash arm assembly 50. It should be appreciated that any number or combination of fixed 78 and mobile dryers 80 may be utilized.

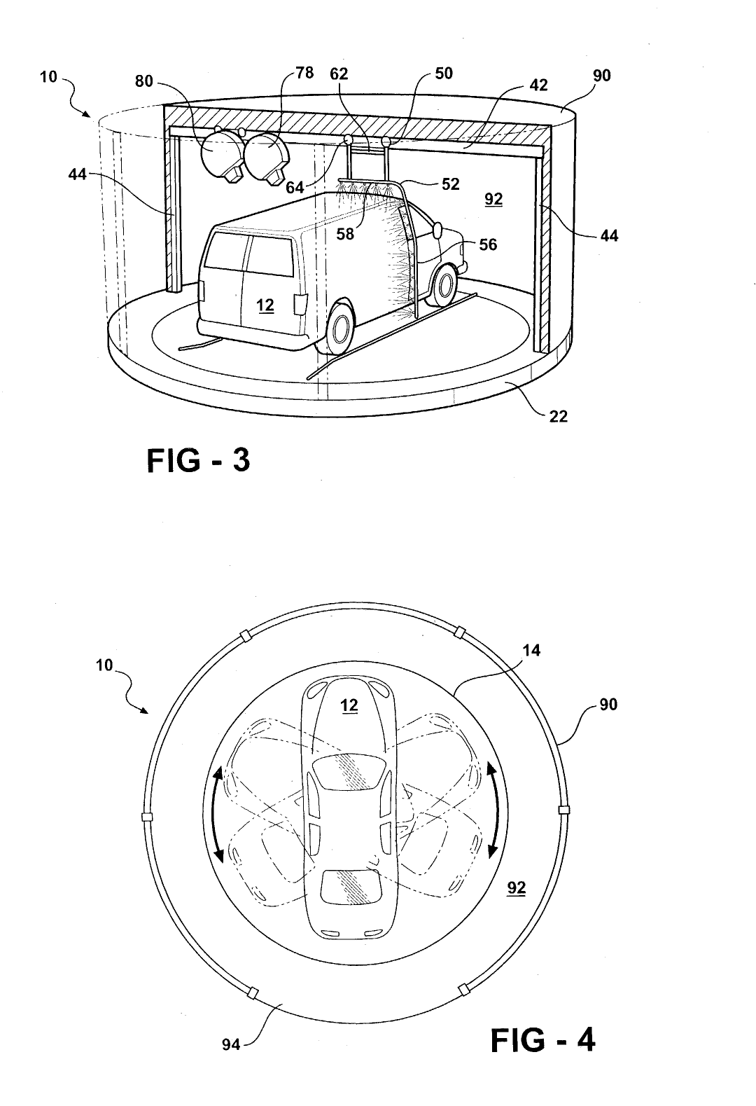

As best shown in FIG. 3, the washing cell 10 also includes a housing 90 for enclosing the base 22 and the support frame 40. The housing 90 is generally cylindrical and defines an interior space 92 for receiving the vehicle 12 therein. The housing 90 includes at least one opening 94 to allow the vehicle 12 to enter or leave the interior space of the housing 90.

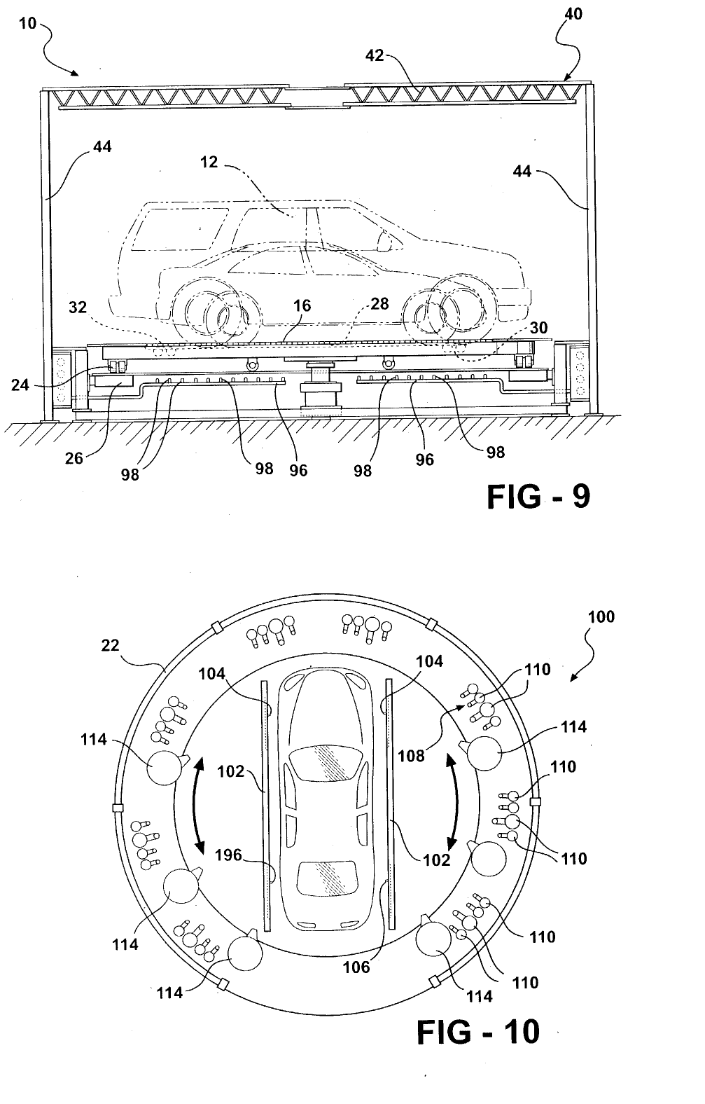

Referring to FIG. 9, the washing cell includes a horizontal pipe 96 extending generally radially under the platform 14, which includes a plurality of holes or spouts 98 disposed longitudinally along the horizontal pipe 96 for spraying fluid through a grating (not shown) in the platform 14 to clean the underside of the vehicle 12.

In operation, the vehicle 12 enters the housing 90 through the opening 94. The wheels of the vehicle 12 are guided by the guide rails 28 in the platform 14. At least one of the front wheels is held in the depression 34 in the guide rails 28 for generally positioning the vehicle 12 in the center of the platform 14. The platform 14 is rotated by the motor 20. At the same time, fluid is pumped through the pipe 52 of the wash arm assembly 50 onto the vehicle 12 as it rotates with the platform 14. During the rotation of the platform 14, the guide rail 68 acts upon the cam follower 70 to radially displace the wash arm assembly 50 along the support rail 46 relative to the vehicle 12.

Fluid is also delivered through the horizontal pipe 96 and sprayed by the spouts 98 onto the underside of the vehicle 12.

To dry the vehicle, fluid to the pipe 52 and the horizontal pipe 96 is shutoff. The platform 14 continues to rotate. Air is pumped through the fixed 78 and mobile 80 dryers onto the vehicle 12 as it rotates with the platform 14. The guide rail 68 continues to act upon the cam follower 70 to radially displace the wash arm assembly 50 along the support rail 46. In turn, the mobile dryer 80 is displaced with the wash arm assembly 50 along the support rail 46 via the pulley assembly 82.

The speed and number of rotations of the platform, the amount and type of fluid delivered through the pipe 52 and the horizontal pipe 96, and the amount of air delivered through the fixed 78 and mobile 80 dryers are controlled by a preselected and predefined wash program controlled by a central processing unit (not shown).

Referring to FIG. 10, an alternate embodiment of the washing cell 100 is shown. A pair of rails 102 is disposed on the top surface 16 of the platform 14. Front 104 and rear 106 nozzles are disposed within each rail 102 for spraying fluid onto the wheels of the vehicle 12. Either or both of the front 104 and rear 106 nozzles are slidably coupled to the rails 102 and are moveable by any suitable positioner (not shown). A plurality of pipe applicator modules 108 is secured to the base 22 along the periphery of the platform 14. Each module 108 includes a plurality of pipes 110 for delivering various fluids through spouts 112 onto the vehicle 12 during rotation of the platform 14. A plurality of dryers 114 are supported by the base 22 and disposed along the periphery of the platform 14 for blowing air onto the vehicle 12 during rotation of the platform 14.

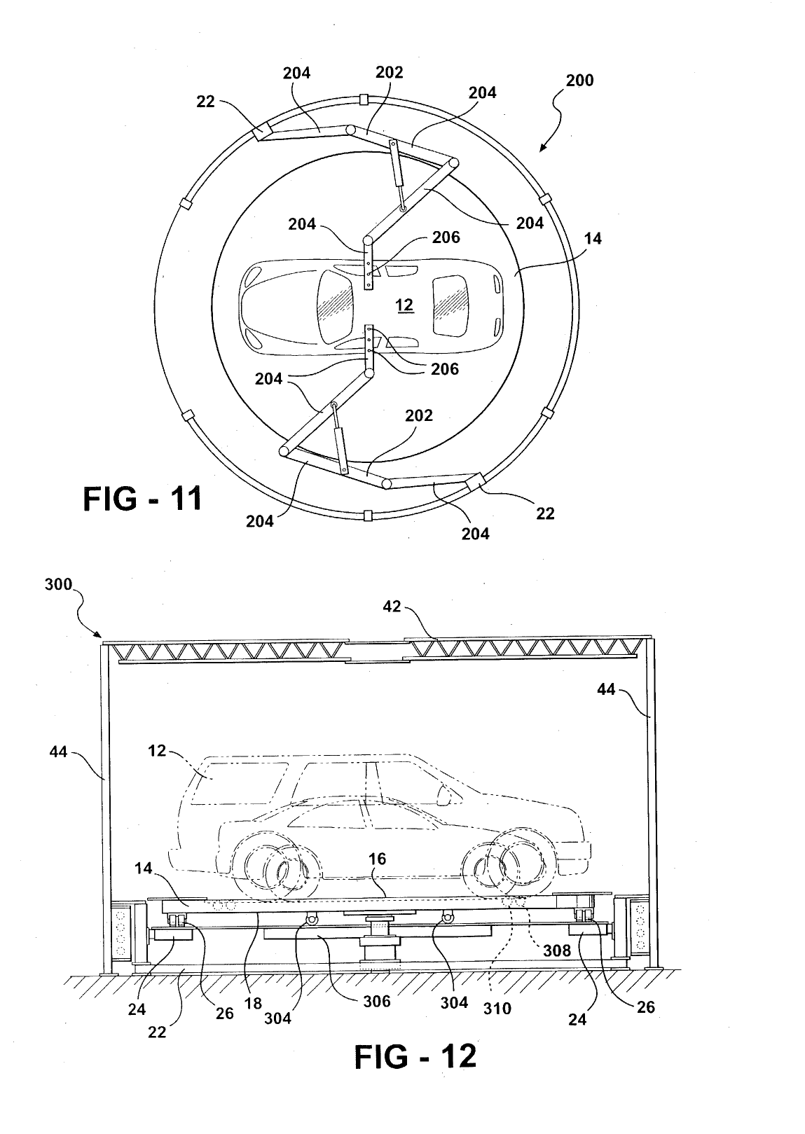

Referring to FIG. 11, a second alternative of the washing cell 200 is shown. An articulating arm 202 is pivotally supported by the base 22. The arm 202 includes at least one, but preferably a plurality of members 204 pivotally coupled to each other, for supporting a pipe applicator module 206. The pipe applicator module 206 includes a plurality of pipes 208 for delivering fluid onto the vehicle through a plurality of corresponding spouts (not shown). The members 204 of the arm 202 are moveable by any suitable controllable positioner (not shown), such as a hydraulic cylinder, for selectively moving and positioning the spouts over the vehicle 12.

Referring to FIG. 12, a third alternative embodiment of the washing cell 300 is shown, wherein rails 302 are movably supported by a set of wheels 304 for movement along a sub-platform 306. The rails 302 receive the vehicle 12 at a first position such that the front wheels of the vehicle 12 are locked between stops 308, 310. The rails 302 are displaced along the sub-platform 306 by suitable positioners (not shown) controlled by a central processor (not shown) in response to a set of sensors (not shown) to center the vehicle 12 with respect to the platform 14.

The invention has been described in an illustrative manner, and it is to be understood that the terminology, which has been used, is intended to be in the nature of words of description rather than of limitation.

Many modification and variations of the present invention are possible in light of the above teachings. It is, therefore, to be understood that within the scope of the appended claims, the invention may be practiced other than as specifically described.

What is claimed is:

1. A rotary car washing cell comprising:
a base;
a platform rotatably coupled to said base for supporting an automotive vehicle and rotating the vehicle about a fixed axis, said platform including a guide rail disposed along a predetermined path on said platform;
a support frame fixedly secured to said base; and
a wash arm assembly for spraying fluid onto the vehicle and slidably supported by said support frame for radial movement with respect to said fixed axis, said wash arm assembly including a cam follower for engaging said guide rail during rotation of said platform, whereby said wash arm assembly is radially displaced with respect to said fixed axis in response to said rotation of said platform about said fixed axis.

2. A rotary car washing cell as set forth in claim 1 wherein said platform includes an upper surface for supporting the vehicle thereon and an opposite lower surface, said opposite lower surface including a plurality of wheels extending therefrom for stabilizing said platform on said base during said rotation of said platform.

3. A rotary car washing cell as set forth in claim 2 wherein said base includes an annular track for receiving said plurality of wheels therein during rotation of said platform.

4. A rotary car washing cell as set forth in claim 3 wherein said support frame includes a cross member supported above said platform by at least one vertical member for slidingly supporting said wash arm assembly for radial movement of said wash arm assembly with respect to said fixed axis.

5. A rotary car washing cell as set forth in claim 4 including a support rail fixedly connected to said cross member and slidably engaged with said wash arm assembly for radial movement of said wash arm assembly with respect to said fixed axis.

6. A rotary car washing cell as set forth in claim 5 wherein said wash arm assembly includes a pipe having a plurality of spouts for spraying fluid onto the vehicle.

7. A rotary car washing cell as set forth in claim 6 wherein said pipe includes a vertical portion for spraying fluid onto a side of the vehicle and a horizontal portion for spraying fluid onto a roof of the vehicle, said vertical portion extending between said horizontal portion and a lower distal end.

8. A rotary car washing cell as set forth in claim 7 wherein said cam follower is fixedly supported by said lower distal end of said pipe.

9. A rotary car washing cell as set forth in claim 8 including an air spring coupled between said cam follower and said lower distal end of said pipe for isolating said wash arm assembly from vibrations from said platform.

10. A rotary car washing cell as set forth in claim 9 including a mobile dryer slidably supported by said support rail for radial movement with respect to said fixed axis.

11. A rotary car washing cell as set forth in claim 10 wherein said mobile dryer is operatively coupled to said wash arm assembly for moving with said wash arm assembly in response to rotation of said platform about said fixed axis.

12. A rotary car washing cell as set forth in claim 11 wherein said upper surface of said platform includes guide rails for guiding the wheels of the vehicle as the vehicle is driven onto said platform, at least one of said guide rails including a depression for retaining one of the wheels of the vehicle therein to define a generally central location of the vehicle on the platform.

13. A rotary car washing cell as set forth in claim 12 having a generally cylindrical housing for enclosing said support frame and the vehicle supported on said platform.

14. A rotary car washing cell comprising:
a base;
a platform rotatably coupled to said base for supporting an automotive vehicle and rotating the vehicle about a fixed axis, said platform including a recessed rail disposed along a predetermined path in said platform;
a support frame fixedly secured to said base; and
a wash arm assembly for spraying fluid onto the vehicle and slidably supported by said support frame for radial movement with respect to said fixed axis, said wash arm assembly including a guide foot slidably engaged with said guide rail during rotation of said platform, whereby said wash arm assembly is radially displaced with respect to said fixed axis in response to said rotation of said platform about said fixed axis.
